(19) United States
(12) Patent Application Publication
(10) Pub. No.: US 2008/0084077 A1
(43) Pub. Date: Apr. 10, 2008

(54) Multi-Purpose Holer

(76) Inventor: Nicholas Alcov, Arroyo Grande, CA (US)

Correspondence Address: Nicholas Alcov, 2398 Callender Rd., Arroyo Grande, CA, 93420, US

(21) Appl. No.: 11/543,656

(22) Filed: Oct. 6, 2006

(51) Int. Cl. A01B 1/00

(52) U.S. Cl. 294/50.7; 172/22

(57) ABSTRACT

A multi-purpose tool capable of boring a hole with a minimal amount of disruption to the surrounding substrate which can aid in clearing over grown lawn sprinklers, for planting, as a post hole digger or for other purposes. The tool also has components which can be disengaged and the pressure nozzle used as a separate tool.

### FIELD OF THE INVENTION

The present invention generally relates to a tool for digging, and more particularly, to a Multi-Purpose Holer used in the creation of holes with a minimal disturbance to the surrounding area. The Holer can pull up a plug of lawn from around an overgrown sprinkler without removing or damaging the sprinkler. It can be used as an auger to dig a trench under a side walk, as a pressure washer or for other purposes.

### BACKGROUND OF THE INVENTION

In the recent time, shovels have been utilized for digging holes. Although there are different sizes of shovels, the lever action upon which the shovels rely, disturbs the area and makes replacement of the surrounding media a broken mix of what was there before hand. Frequently the importance of maintaining the appearance of the area is as important as the reason for creating the hole, as in the example of a manicured lawn or a golf putting green. A broken utility or sprinkler line or an over grown sprinkler are best served with the use of the Multi-Purpose Holer. Post hole diggers use a pinching action which also disturbs the area and would break a sprinkler. The Multi-Purpose Holer can create holes for planting and simultaneously soak the ground as is often recommended to promote root growth.

There are improvements on the shovel, for example, U.S. Pat. No. 7,070,006 discloses a shovel with wings for improvement, but the lever action would still break or pull up a sprinkler and disturbs the lawn to a greater degree than with the Multi-Purpose Holer.

U.S. Pat. No. 6,439,629 describes an improvement on a post hole digger, but it still uses the pinching jaws which would damage a sprinkler head and mixes the lawn with the soil harming the appearance of the lawn.

None of the prior art particularly teaches a system that enables one to remove a plug while creating a hole with a minimal of disruption to the surrounding area. Nor allows one to remove the soil from around a sprinkler head or other protuberance with out damage to the sprinkler or protuberance. Nor provides a tool with multiple uses as will be described

Accordingly, there is a need for a tool to assist gardeners and repairmen in creating a hole and repair the lines under the ground with a minimal amount of damage to the surrounding area.

### SUMMARY OF THE INVENTION

In view of the foregoing disadvantages in the prior art, the present invention provides a tool to make a hole which saves a plug which can be replaced if desired. The tool creates this hole with a minimal amount of disruption to the appearance of the area. In addition the tool can remove this plug from around a sprinkler or other protuberance without damage to the protuberance. The present invention also include the advantages of the prior art and overcome the drawbacks inherent therein.

In one aspect, the present invention provides a tool consisting of a hollow body, preferably a cylinder, attached to a handle, preferably hollow. A neck, preferable hollow, may be positioned between the body and handle to bring the handle to a comfortable height. On the Multi-purpose Holer is a opening or vent which can be covered with a portion of the hand such as a finger. By applying downward pressure and rotating the handle, a boring action is created. By keeping the vent covered while pulling upward on the handle, suction is created and a plug is removed from the ground. Generally this plug can be replaced if desired thus maintaining a neat appearance to the area.

In another aspect of the present invention, the cylinder will have a plurality of saw like teeth to assist in cutting through the substrate, roots, or other obstructions contained in the medium in which the tool is being utilized.

In another aspect of the present invention the saw like teeth are connected to the body in a manner such that they can be replaced when worn, broken or teeth with other characteristics are desired.

In still another aspect of the present invention a source of connection is available to attach a hose to deliver an agent such as water to aid in the digging process.

In yet another aspect of the present invention, a valve to regulate the flow of the agent is included in the Multi-Purpose Holer to assist in the digging process.

In still another aspect of the present invention a pressure nozzle is included in the tool to blast away opposing media.

In yet another aspect of the present invention, portions of the tool can be removed from the body to create an auger capable of trenching, for use as a pressure washer or for other purposes.

In yet another aspect of the present invention, portions of the tool can be removed from the body and reassembled to create a longer auger capable of trenching as under sidewalks, for use as a pressure washer with a longer reach, or for other purposes.

These together with other aspects of the present invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the present invention.

### BRIEF DESCRIPTION OF THE DRAWINGS

The advantages and features of the present invention will become better understood with reference to the following more detailed description and claims taken in conjunction with the accompanying drawings, wherein like elements are identified with like symbols, and in which:

FIG. 1 is a perspective view of a sheet of material 10 illustrating a plurality of saw like teeth of which some 11 are beneficial when rotating the Multi-Purpose Holer in one direction while others 12 are beneficial when rotating the Multi-Purpose Holer in the other direction, according to an exemplary embodiment of the present invention;

FIG. 2 is a perspective view of the Multi-Purpose Holer illustrating the handle 21, body 24, and saw like teeth 25 according to an exemplary embodiment of the present invention;

FIG. 3 is a perspective view of the Multi-Purpose Holer illustrating a foot bar 30 which can aid in applying downward pressure, according to an exemplary embodiment of the present invention;

FIG. 3A is a perspective view of the Multi-Purpose Holer illustrating a removable foot bar 30 with screw on connectors and plugs according to an exemplary embodiment of the present invention;

FIG. 4 is a perspective view of the side of the neck and handle illustrating a connection 42 to attach a means of adding an agent such as water, according to an exemplary embodiment of the present invention;

FIG. 5 is a perspective view of the side of the neck and handle illustrating a regulating valve 50, according to an exemplary embodiment of the present invention;

FIG. 6 is a perspective view of the side of the neck and handle illustrating a pressure nozzle 60, according to an exemplary embodiment of the present invention;

FIG. 7 is a perspective view of the side of the neck and handle illustrating connectors 73 and complimentary connections 74 used to create an auger and/or pressure washer, according to an exemplary embodiment of the present invention;

FIG. 8 is a perspective view of the side of the body illustrating a connector 81 with replaceable saw like teeth, according to an exemplary embodiment of the present invention

Like reference materials refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular Multi-Purpose Holer as shown and described. It is understood that various omissions and substitutions of equivalents are contemplated as circumstances may suggest or render expedient, but the description is intended to cover the application or implementation without departing from the spirit or scope of the claims of the present invention.

The terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

The present invention provides a tool for creating holes with a minimal amount of disruption to the surrounding area. While the examples provide uses in soil, use on other surfaces may also apply. The present invention provides a tool which can be utilized to remove a plug of lawn and soil from around an over grown sprinkler without damage or removal of the sprinkler. The PVC pipes providing water to these sprinklers break and need repair as do other types of utility lines. With the Multi-Purpose Holer a plug of lawn and soil can be removed from over the break. Once the repair to the line is complete, the plug can be replaced for the lawn to re-grow. This provides a neat repair without the mound of soil that is generally left if a shovel is used. The Multi-Purpose Holer is ideal for planting in that it provides a neat hole and simultaneously soaks the soil as is often recommended for root growth. The present invention can also be used for digging post holes. In another embodiment, portions of the Multi-Purpose Holer with its pressure nozzle, can also be utilized as an auger for digging a trench as under a sidewalk for routing utility lines, as a pressure washer, or for other purposes.

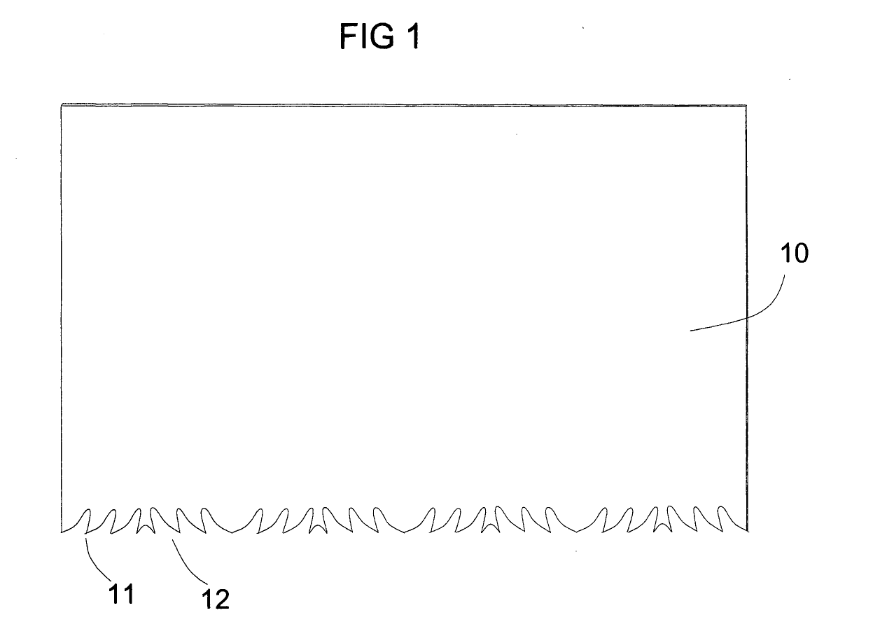

FIG. 1 illustrates a sheet of material 10 such as Galvanized steel, aluminum and the like, suitable to withstand the rigors of digging and the weight applied on the tool, with a plurality of saw like teeth 11 and 12. The sheet would be rolled and the ends joined by weld or other means, to create the body, preferably a cylinder. The cylinder could be constructed in various diameters and heights determined by the size of the hole which is desired. The plurality of saw like teeth are arranged so that cutting would occur when the cylinder is rotated in either a clock wise or counter clock wise direction. Other mean such as boring out a block of material could also be utilized to create the body.

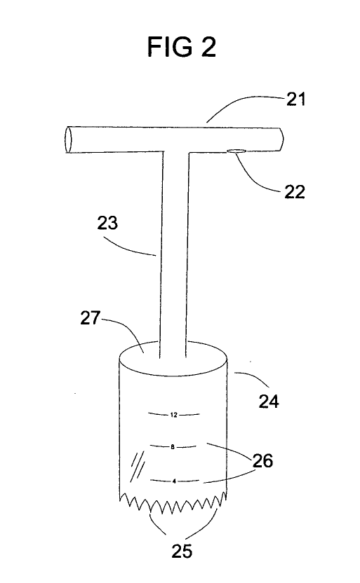

FIG. 2 illustrates a Multi-Purpose Holer comprised of a hollow body 24, containing a plurality of saw like teeth 25 preferably at the bottom of the body. The material of which these teeth are composed, as well as the size, angle and other characteristics will be dependant on the substrate in which the boring will occur. Preferably the saw like teeth will have a directionality and shape such that some will provide cutting when the cylinder is rotated in a clock wise direction, while others will provide cutting when the cylinder is rotated in a counter clock wise direction. A cap, 27 covers the top of the hollow cylinder 24 by means such as weld, screw on threads, and the like. A hollow neck 23 attaches to an opening in the cap 27 by means such as weld, screw on threads, locking tabs and the like. A hollow handle 21 is attached to the neck by means such as weld, screw on threads, locking tabs and/or the like. The ends of the handle are sealed by welds, threaded plugs attached to the handle ends by complimentary screw threads, or other means to seal the ends. A vent 22 is located on the Multi-Purpose Holer in a position that can be easily covered with a finger, thumb or portion of the hand. This vent 22 can have screw on threads so a plug with complimentary screw on threads, can be inserted if desired, or a shut off valve could be utilized for venting. Demarcations 26 indicating the depth of the hole created, would be beneficial to determine the depth of the hole for planting as well as estimating how close the tool is to a utility line. While the drawing and descriptions depict the handle as a tube shape, other shapes such as a wheel may be easier to turn. In addition the handle may attach directly to the body without a neck or on a location on the neck other than that shown. For example, for use as a post whole digger, since the hole will be deeper than for use in planting, the size of the body, neck and handle as well as where and how they are positioned as well as the relation to where the connector are located for the water source will vary.

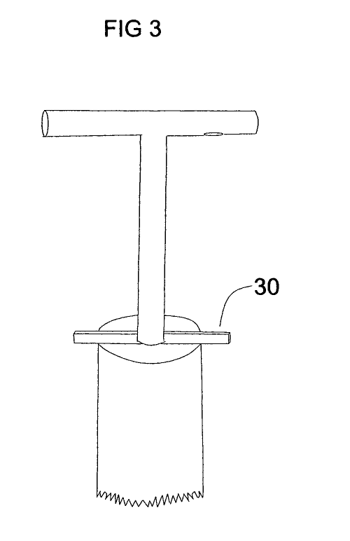

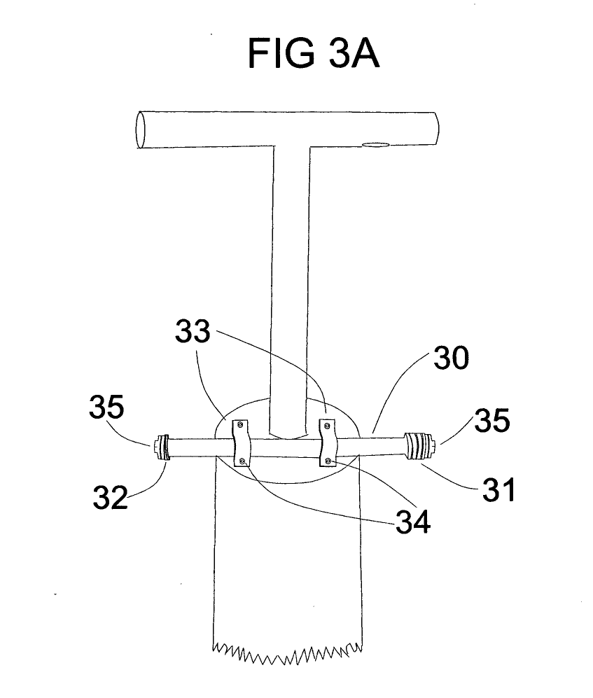

In an other embodiment of the present invention, a foot bar 30 as illustrated in FIGS. 3 and 3A is provided to apply downward pressure to aid in the digging process. In FIG. 3 the foot bar 30 is attached permanently by weld or other suitable means. In FIG. 3A the foot bar 30 is attached by a means such as straps 33 held down by bolts and nuts 34 or other means, such that the foot bar 30 can be removed. The foot bar would have connections such as screw on threads 31 and 32 which compliment other screw on threads on other portions of the Multi-Purpose Holer such as the neck and/or handle to create an auger as will be detailed later. Plugs 35 with complimentary attachment features would cover openings at these connections when the portion are disassembled.

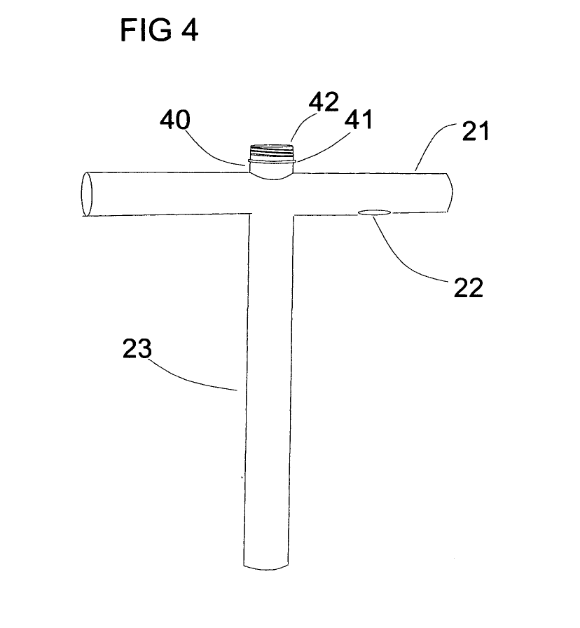

In another embodiment of the present invention a connection 42 is provided as illustrated in FIG. 4. This is attached to the top of the handle by means of weld 40, threaded connection, locking tabs or other means which will provide an air, as well as water tight seal. A means such as a rotating gasket connection 41 is provided to connect a source for the addition of an agent such as a water, as from a garden hose to not rotate as the handle is rotated. The agent interacts with the substrate as for example a water source moistens the ground to aid in the digging process or could enhance the performance of the saw like teeth as for example an agent used to prevent the saw like teeth from over heating. Other agents, in the state of solid, liquid, gas, and/or any combination may be utilized based on the substrate in which the boring is to occur.

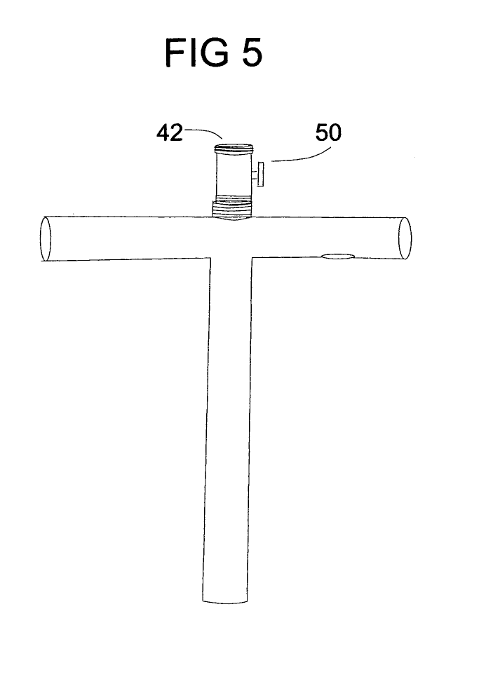

In another embodiment of the present invention, a means such as a shut off valve 50 as illustrated in FIG. 5 to regulate the flow of water is provided on the connection 42 for the water source. Other means for regulating water flow such as a twist type valve as seen on garden hose nozzles, or other appropriate methods can be applied

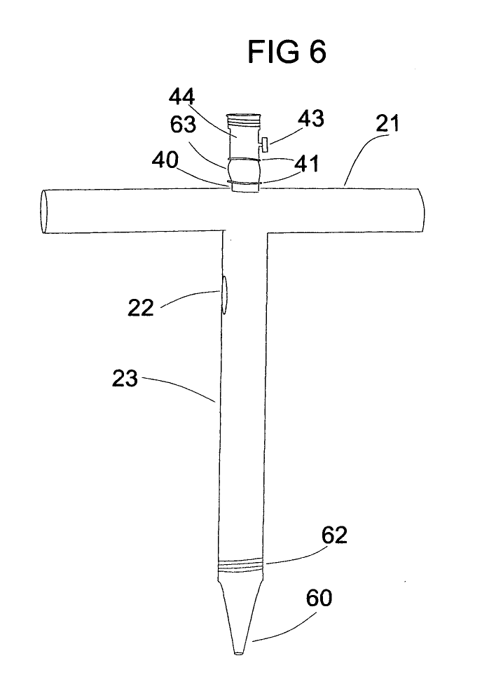

In another embodiment of the present invention, a pressure nozzle 60 as illustrated in FIG. 6 is included in the Multi-Purpose Holer. The pressure nozzle 60 can be preferable attached at the juncture of the neck 23 and body (not shown), but other locations may prove beneficial, or the nozzle can protrude further into the body than shown. The neck 23 with the pressure nozzle 60 can be permanently attached by weld or other means to the body (not shown), or the neck 23 with the pressure nozzle 60 can be attached to the body (not shown) by screw on threads 62, snap on connector, or other means which allows them to be disconnected from complimentary connectors located on the body. The vent 22 would be located in an ergonomic location as determined by the dimensions of the tool. A rotating knuckle 63 for the water source would allow a greater degree of movement of the hose. The neck with the pressure nozzle can be utilized as an auger to blast holes and trenches with water pressure, hose down the sidewalk or for other purposes.

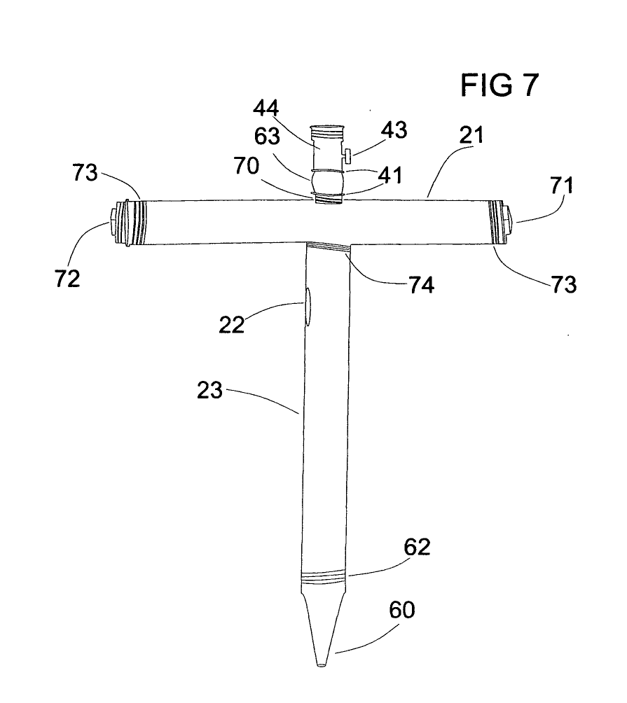

In still another embodiment of the present invention, the handle 21 could be unscrewed from the complimentary connection 74 at the neck 23 which is illustrated in FIG. 7. The handle 21 could then be connected to the neck 23 by a threaded screw on connector 73 or other suitable means to create a longer auger. Plugs 71 and 72 would be removed from the complimentary connections 73 and utilized to plug the openings which are created by the disassembly when the water source connector 70 is removed from the middle of the handle and attached at the complimentary connection 73 at the other end of the handle. The vent 22 in this model would be located in a ergonomic location which provides a comfortable way of covering it with a portion of the hand. A shut off valve (not shown) is another possible means of regulating the venting of the Multi-Purpose Holer. For an even longer auger the foot bar 30 as described in FIG. 3A can be connected into the series with the neck 23 and handle 21. This longer length would be beneficial for digging trenches as under a sidewalk for routing utility lines, extend the reach of the pressure nozzle as for high places, or for other possible uses.

In yet another embodiment of the present invention, the neck, and/or the handle, and/or the foot bar could have telescopic characteristics (not shown) to increase the length further. When all of these are connected together an even longer extension is created for the pressure nozzle.

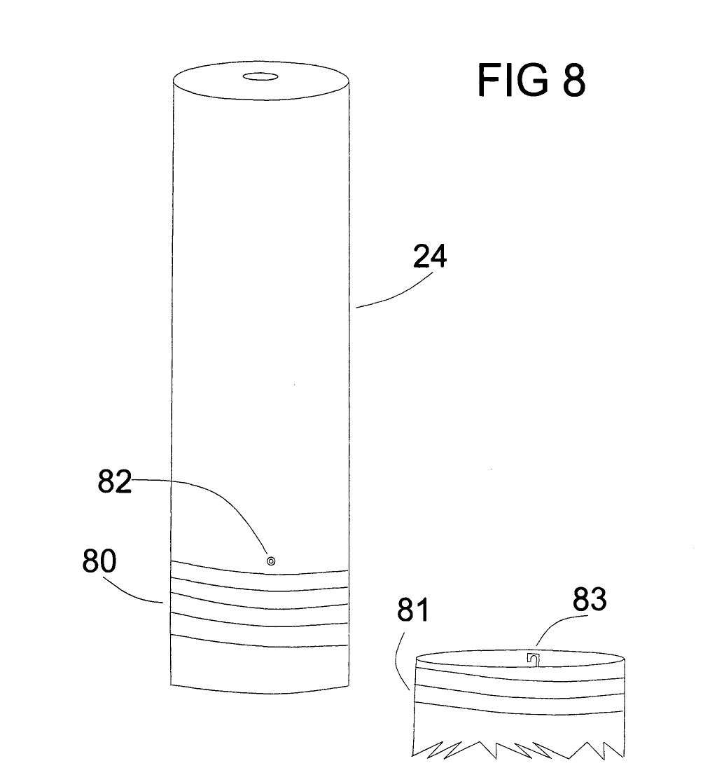

In yet another embodiment of the present invention, the saw like teeth are designed to be replaceable when they get dull, broken, or teeth with different characteristics are needed for different substrates. FIG. 8 illustrates one possible means for replacing the saw like teeth utilizing a screw on connector 81 for the saw like teeth, engaging with a complimentary connector 80 on the body 24. One possible means out of many for preventing the pieces from unscrewing during the rotation of the Multi-Purpose Holer, could include a stud 82 on the body 24, engaging with a locking tab 83 on the teeth.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstances may suggest or render expedient, but is intended to cover the application or implementation without departing from the spirit or scope of the claims of the present invention.

What is claimed is:

1. A Multi-Purpose Holer, comprising a hollow body with saw like teeth, to which is attached a handle, either directly to the body or to a hollow neck which attaches to said body, by rotating the handle, the saw like teeth are capable of boring a hole, said hollow body is capable of extracting a plug out of the substrate in which said teeth bore, when a vent which is provided is closed off and said handle is pulled upward.

2. The Multi-Purpose Holer of claim 1, wherein said saw like teeth are able to be disengaged and replaced.

3. The Multi-Purpose Holer of claim 1, wherein a foot bar is provided.

4. The Multi-Purpose Holer in claim 1, wherein a means is provided to supply an agent to aid in the boring.

5. The Multi-purpose of claim 1, wherein a means to regulate the amount of agent is provided.

6. The Multi-Purpose Holer of claim 1, wherein a pressure nozzle is included.

7. The Multi-Purpose Holer of claim 1 wherein components containing said pressure nozzle can be disengaged from said body and utilized separately.

8. The Multi-Purpose Holer of claim 1, wherein components can be combined in an alternate fashion to increase the length.

9. The Multi-Purpose Holer of claim 1, wherein telescopic portions of the components increase the length.
